(19) United States
(12) Patent Application Publication
(10) Pub. No.: US 2007/0022656 A1
(43) Pub. Date: Feb. 1, 2007

(54) Retainer for preventing flower pot from tipping

(76) Inventor: Theresa N. Powless, Pontiac, MI (US)

Correspondence Address: HARNESS, DICKEY & PIERCE, P.L.C., P.O. BOX 828, BLOOMFIELD HILLS, MI, 48303, US

(21) Appl. No.: 11/544,356

(22) Filed: Oct. 9, 2006

Related U.S. Application Data
(62) Division of application No. 11/065,736, filed on Feb. 25, 2005.
Application No. 11/065,736 is a continuation-in-part of application No. 10/716,208, filed on Nov. 18, 2003, now Pat. No. 7,013,598.

(51) Int. Cl. A01G 9/02

(52) U.S. Cl. 47/66.6

(57) ABSTRACT

A retainer is provided to prevent a conventional flower pot, which is supported upon the ground and which may be tipped over by wind forces or other lateral forces. The retainer is formed of an elongated, thin metal wire bent into an elongated stem portion with a downwardly opening hook on one end. The hook is engaged over the upper edge portion or rim of the pot with the stem extending downwardly along the side of the pot and into the ground beneath the pot. The stem is curved along its length so that when the retainer is manually attached to the pot, the stem enters the ground adjacent the bottom edge of the pot and moves underneath the pot bottom radially inwardly from the wall of the pot. The wire may be coated with a roughening paint-like material so as to increase the frictional grip between the stem and the ground.

### CROSS-REFERENCE TO RELATED APPLICATIONS

This application is a divisional of U.S. patent application Ser. No. 11/065,736, filed Feb. 25, 2005, which is a continuation-in-part of my prior application, U.S. patent application Ser. No. 10/716,208, filed on Nov. 18, 2003.

### FIELD OF THE INVENTION

This invention relates to a method and a retainer for holding a conventional flower pot from tipping over accidentally due to laterally-applied forces of the wind or accidental contacts.

### BACKGROUND OF THE INVENTION

Conventional flower pots, which are typically made of plastic materials or clay or the like, and are normally filled with a potting material or dirt to hold flowers or other plant materials, have a tendency of tipping over when subjected to laterally-applied forces from wind or physical contacts. Thus, it would be desirable to provide a simple, inexpensive device which would retain the flower pot against tipping over on its side when lateral forces are applied thereto.

Devices for holding a flower pot have been known in the past. One example of such a device is disclosed in U.S. Pat. No. 5,836,105 issued Nov. 17, 1998 to Ronald E. Loosen for “Nursery Pot Stabilizing Device.” In general, the device disclosed in that patent involves a flower pot holder which has a base which is provided with openings. Hooks engage the holder base through its openings and extend into the ground to hold the pot upon the ground. However, that device is relatively expensive and is cumbersome in use and thus, is not readily useful in connection with conventional flower pots. To be practical, the holder must be sufficiently inexpensive to use with a substantial number of ordinary clay or plastic flower pots which are typically provided by retail plant sales establishments. Frequently, conventional pots containing plants are placed on the ground near homes, cemetery gravesites and other places for the temporary display of potted flowers. Since these are commonly used in substantial quantity, it is essential that the holding device be extremely inexpensive and simple in construction and operation.

Other examples of devices that have been disclosed for the purpose of holding a flower pot upon the ground and preventing the pot from tipping over, are described in the following prior patents: U.S. Pat. No. 1,902,423 issued Mar. 21, 1933 to W. H. Seltzer for “Flower Holding Device”; U.S. Pat. No. 5,279,070 issued Jan. 18, 1994 to Gerald C. Shreckhise for a “Plant Growing Receptacle and Method”; U.S. Pat. No. 2,861,764 issued Nov. 25, 1958 to Delphis Fischer for a “Receptacle Holder”; U.S. Pat. No. 1,846,433 issued Feb. 23, 1932 to Percival F. Morley for a “Flower and Plant Holder”; French Patent No. 2,557,761 published Jul. 12, 1985 to Daniel Naas for a “Device for Stabilizing Flower Pots”; French Patent No. 2,481,881 published Nov. 13, 1981 to Andre Franclet, illustrating a “Flower Pot Retaining Device for Holding a Pot Upon the Ground”; French Patent No. 1,148,341 published Dec. 6, 1957 to M. P. Jean-Xavier Dagnaud for a “Holder for Vases and Pots”; U.S. Pat. No. 3,273,841 issued Sep. 20, 1966 to J. G. Cota for a “Device for Holding Flower Receptacle in Upright Position”; and U.S. Pat. No. 2,513,461 issued Jul. 4, 1950 to Thomas P. Duncan, Jr. for a “Device for Holding Flowers.”

Each of the retaining devices disclosed in the foregoing patents is relatively expensive, particularly where a substantial number of them may be needed for temporarily holding a considerable number of flower pots in one garden area, for example, at one time. These prior devices, for the most part, are formed to support a single-size pot. However, flower pots that are conventionally used come in different shapes and sizes so that an inventory of retainers of different sizes would be needed for holding an assortment of pots which vary in sizes. The devices disclosed above, in general, lack the ability to hold pots of different sizes within a relatively wide range of sizes.

Hence, it would be desirable to have a simplified, very inexpensive, retainer which may be used on an assortment of different size and shape flower pots to securely hold a flower pot upon a ground surface or other surfaces, against tipping over when subjected to wind forces or contact forces which are applied laterally against the pot or against the plants that extend upwardly from the pot.

### SUMMARY OF THE INVENTION

The present invention contemplates a simplified retainer and an easy method for applying the retainer for immobilizing a conventional flower pot rested upon a ground surface or similar surface. The device comprises an elongated wire stem having an upper end that is bent into a downwardly opening hook which fits over and holds an upper edge portion of the rim of a conventional flower pot. The stem extends downwardly from the rim of the pot closely along the wall of the pot and into the ground for a sufficient depth to hold the retainer in place and to enable the retainer to stabilize the pot against tipping.

In many instances, a single retainer, as described above, would be sufficient to hold a pot against tipping. However, where a single retainer is not sufficient, due to the size or shape of the pot or the anticipated forces of the wind or physical contacts which are laterally applied against the pot or the flowers or plants within the pot, two retainers may be used, one on each opposite side of the pot.

Preferably, the stem is bent into a curve which closely simulates a segment of a circle. Thus, the curved stem extends downwardly from the hook portion at its upper end, along the side of the pot, into contact with, or closely adjacent to, the corner portion formed by the intersection of the pot wall and the bottom of the pot, and then continues downwardly into the ground beneath and inwardly of the area of the bottom of the pot. In applying the retainer, it may be grasped manually, and placed into contact with the upper edge or rim of the pot and the lower corner, i.e. the junction between the wall and the bottom of the pot, and pushed downwardly until the hook engages the upper portion or rim of the pot while the lower portion slides endwise into the ground beneath the pot bottom.

An alternate arrangement may be used where the pot is supported upon a patio or walkway or other surface made of boards or the like where there are spaces between adjacent boards. There, the lower end of the stem would be passed through the space between a pair of boards and then bent underneath the board supporting the pot for holding the retainer and pot in place. Further, it is contemplated to coat the wire forming the stem and hook portion with a conventional paint-like coating, as for example a suitable, commercially available paint containing roughening particles, such as sand or some other conventionally available rough surfacing material. The coating substantially increases the frictional grip between the retainer and the ground into which the retainer is inserted, thereby resisting any tendency for the retainer to inadvertently pull out of the ground.

One object of this invention is to provide an extremely inexpensive retainer in the form of a conventional, stiff, metal wire strip of sufficient length to extend around the upper edge of the pot and then downwardly from the upper edge of the pot, along the side of the pot and into the supporting surface beneath the pot bottom. With that configuration, the retainer applied on one pot will not interfere with the retainer or an adjacent pot when a pair of pots is arranged close together. The pot is anchored to the area of the ground that is just beneath its bottom.

A further object of this invention is to provide a retainer which is easy to apply, requires minimal effort or force to apply it, and which will nevertheless hold a pot against relatively strong lateral forces that may be applied laterally against the pot or its contents.

Still another object of this invention is to provide a retainer made of a length of a metal wire which is so inexpensive and easily stored or displayed, that substantial quantities of these retainers may be available to a gardener or other user at relatively low cost.

These and other objects and advantages of this invention will become apparent upon reading the following description, of which the attached drawings form a part.

### DESCRIPTION OF THE DRAWINGS

FIG. 1 is a perspective view illustrating a pair of retainers attached to a conventional flower pot rested upon the ground. Plant material, which is schematically shown in dotted lines, extends upwardly from the pot.

FIG. 2 is a schematic view of a fragment of the pot with a retainer hooked over a conventional pot of the type having an upper, circumferential, wide band portion formed integrally with the pot. Conventional clay-type pots frequently are formed with such a band.

FIG. 3 is a cross-sectional view of another conventional type of flower pot which is rested upon the ground and is held by a pair of retainers located on diametrically opposite sides of the pot for anchoring the pot to the ground area that is beneath the bottom of the pot.

FIG. 4 is a schematic illustration of the pot of FIG. 3 with the retainers shown in different positions as the retainers are applied upon the pot.

FIG. 5 illustrates a retainer whose hook portion is formed in a hairpin-like shape for gripping the upper edge or rim of a pot.

FIG. 6 is a similar illustration of a modified retainer having its upper edge portion bent offset relative to the remainder of the lower portion of the stem for more closely engaging a pot which has a bulged or outwardly extending upper rim portion, as illustrated, for example, in FIG. 2.

FIG. 7 illustrates a modified form of a retainer having a lower end laterally bent to form a lower holding member.

FIG. 8 schematically illustrates a pot rested upon a board type support, such as a deck or balcony, or patio floor or walkway, with the lower holding member engaging the lower surface of a supporting board.

FIG. 9 illustrates a fragment of a wire forming the retainer, which is provided with a roughened coating to provide a high frictional grasping surface on the retainer.

### DETAILED DESCRIPTION OF THE PREFERRED EMBODIMENTS

Referring to the drawings, which illustrate preferred embodiments of this invention, a conventional flower pot of the molded clay type, 10 is illustrated as resting upon the ground. The pot may be made of a plastic material, such as illustrated in FIG. 2, or of a conventional clay material or, in some cases, of sheet metal or cardboard-like composition material. The particular shape and size of the flower pot and the material of which it is made, is not relevant to this invention and may vary.

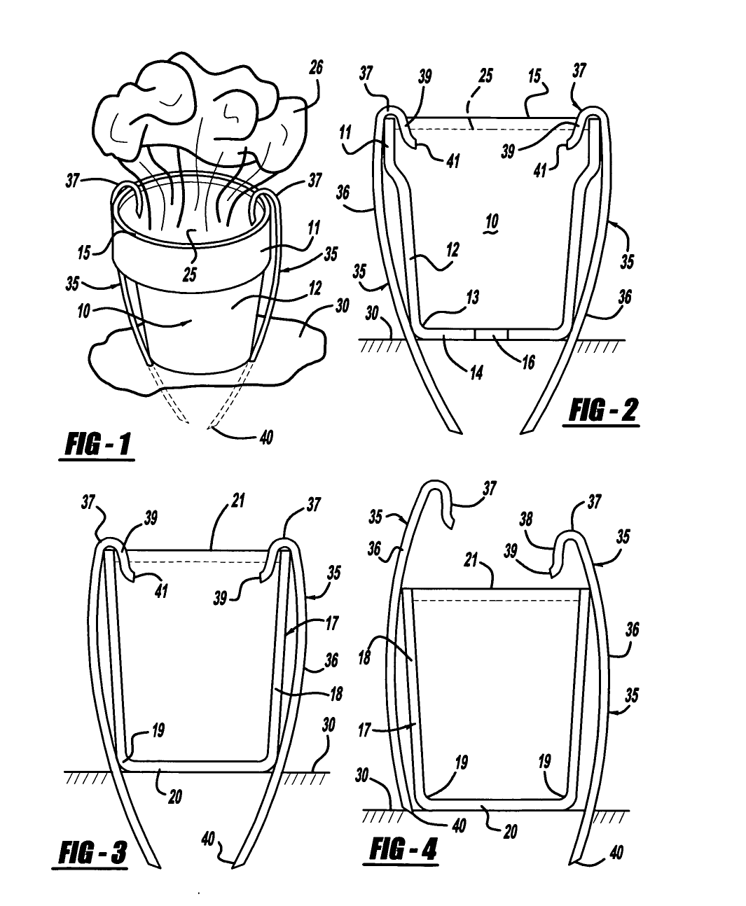

The pot 10 illustrated in FIG. 1 is provided with a conventional upper, circumferential band 11, which is a widened or substantially cylindrically-shaped band integrally formed on the upper edge portion of the pot wall. The lower part of the pot is formed by a wall or body portion 12 which, conventionally, is tapered downwardly and inwardly. The lower, corner part 13 of the tapered wall joins to a substantially closed base 14. Thus, the upper edge or rim 15 which surrounds the open upper part of the pot, would normally be of a greater diameter than the base 14 of the pot. The base may have one or more holes 16 for draining water from the pot (see FIG. 2).

FIGS. 3 and 4 illustrate another conventional pot 17 which does not have the bulge or enlarged upper edge band. The wall 18 forming such a pot may be tapered downwardly and inwardly, or may be substantially vertical. The lower, corner edge 19 of the wall is integral with the base 20. The upper edge of the wall forms a rim 21. Pots of this shape are conventional and equally applicable for use with the present invention.

The pots as schematically illustrated in the drawings are typically filled with a potting material or dirt 25 for containing a plant 26. The plant 26 is schematically illustrated. It may be a single flower plant or a number of flower plants or a bush or some other plant-type of material which are commonly sold or potted or planted by gardeners in flower pots. Similarly, the flower pot may be round or formed in an elongated trough-like or rectangular shape.

It is contemplated that the flower pot will be supported upon the ground 30 which is comprised of some penetrable material, such as earth or pebbles, etc. By way of example, it is common to display potted flower pots or potted plants, at gravesites in cemeteries for various occasions, such as the deceased person's birthday, anniversary of death, mother's/father's day, or Christmas. Potted flower pots and potted plants are commonly used in outdoor settings in garden areas or in landscaped areas around houses or other buildings. In these instances, it is common to temporarily place flowers or other potted plants and to replace them periodically when necessary or desired.

In each of these uses, the flower pots, which may be relatively small, may be subjected to lateral wind forces or other physical disturbances or inadvertent laterally-applied physical forces, such as by some object, or small animal or person bumping into them, which may cause the pots to tip over onto their sides. This is a common occurrence. The essential purpose of the retainers herein is to prevent such tipping from occurring.

The retainer 35, as illustrated for example, in FIGS. 2 and 3, comprises an elongated stem 36 which is preferably made of a thin diameter metal wire, such as a suitable steel or aluminum wire, which is relatively stiff. The upper end of the stem is bent into a downwardly opening hook 37. Preferably, the metal forming the retainer is slightly resilient. Thus, the hook may be forced over the rim of the pot for resiliently gripping the rim between the legs which define the hook shape. Alternatively, the hook may be wide enough, i.e. with a relatively wide space between the legs forming the hook, and sufficiently stiff to simply fit over, without tightly gripping the rim. The free edge 38 of the short leg 39 of the hook may be bent outwardly for ease in guiding the hook over the rim.

The lower end of the stem is preferably formed with a sharpened or pointed end 40 which assists in penetrating the ground when the retainer is pushed downwardly into position for holding a pot. Similarly, the free end of the short, outer leg 39 of the hook 37 may be formed with a sharpened or pointed end 41 (see FIGS. 2 and 5) for penetrating more easily into the material contained within the pot.

The stem is preferably bent along its length into a curvature which is generally similar to the shape of a segment of a circle. Thus, referring to FIG. 4, the user of the retainer may position the retainer against a side of the pot with the retainer stem contacting the lower corner 19 and the edge of the rim 21 of the pot, that is, against the junction between the bottom of the pot wall and the base and upper rim, as schematically shown in FIG. 4. Then, with the retainer guided by its contact with the rim and the lower junction, while pushing the retainer downwardly, the lower end portion of the stem is inserted into and pushed into the ground beneath the bottom of the pot. The lower portion of the stem will extend downwardly beneath the bottom of the pot until the hook engages and holds the upper edge of the pot as shown in FIG. 3.

With this simplified method, the positioning of the retainer, or retainers if more than one is used, is easily accomplished with minimal effort and force. Since the lower part of the stem is within the area directly beneath the bottom of the pot and the main portion of the stem is close to the pot wall, the retainers do not extend any significant distance sideways from the walls of a pot where they could interfere with adjacent pots when two or more pots are closely arranged. Moreover, the retainers are close enough to the pot wall so that ordinarily they cannot be disturbed by wind or by physical objects contacting the pot wall. One or two retainers are ordinarily sufficient to hold most, if not all, pots against tipping even though the pot may be subjected to a substantial lateral force, such as a high wind gust or a physical contact which may happen, for example, when lawn mowers or other landscaping equipment accidentally touch a flower pot.

Because of the curvature of the stem, whose lengthwise movement into the ground is guided by the contact with the pot upper and lower wall edges, the pot serves to properly direct and position the lead end of the retainer beneath the pot as indicated in the drawings. Although it is preferred that the user physically touch the retainer stem against the lower corner or junction of the pot wall-bottom and the rim, the retainer may still be applied even though it may be slightly spaced from contact with the pot.

Preferably, the wire 46 forming the retainer is covered with a coating 47 of a paint-like material which provides a roughened surface finish (see FIG. 9). Such types of coating material are available commercially. Thus, the selection of the material for coating the wire with a rough, high friction surface, may be made by those skilled in the art. Such selection depends upon the commercial availability of a suitable paint-like, durable, material which can be applied by dipping or spraying the wire with material which will resist adverse environmental conditions, as for example, the ground, water, freezing temperatures, etc.

FIG. 5 illustrates a modified shape of the retainer 50 whose hook portion 51 is bent into a hairpin-like hook configuration so that it will resiliently grasp the upper edge of the pot. The short leg 52 of the hook, preferably terminates in an outwardly curved bent end portion 53 that terminates in a sharp point 41 to facilitate slipping the hook over the rim of a pot and into the contents of the pot. Otherwise, the structure is similar to that described above.

FIG. 6 illustrates a modified retainer 55 having the upper end portion 56 of the stem offset bent relative to the axis of the curved major portion 57 of the stem. The hook itself is formed similarly to that shown in FIG. 5. Thus, this retainer may closely engage or grasp the offset, upper band-like portion 11 found on many of the commonly used clay-type flower pots.

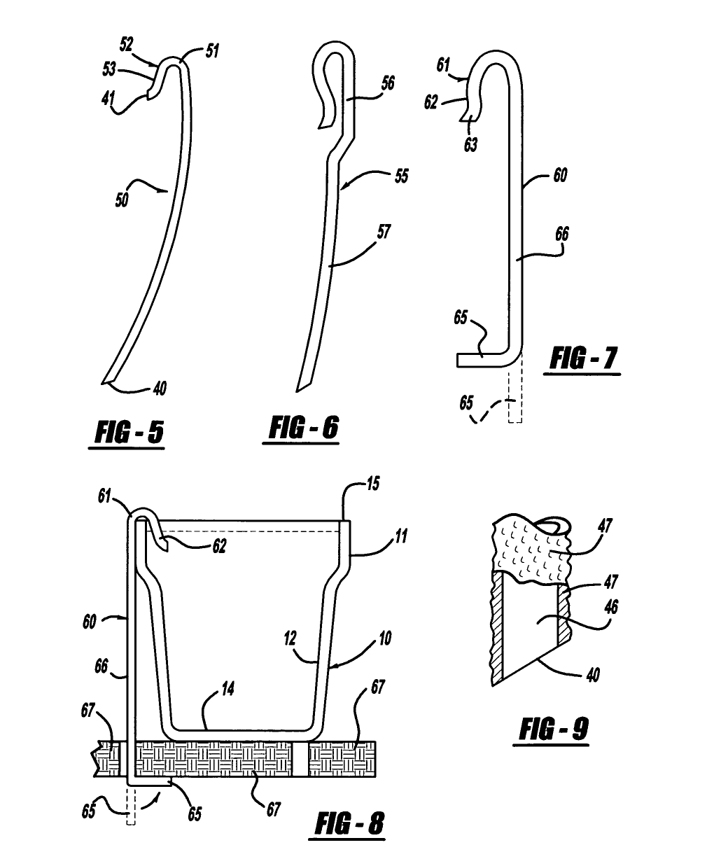

FIG. 7 illustrates a modified retainer 60 having its upper end formed into a wider, or more open, hook-shape 61 whose short leg 62 terminates in a bent end 63. The lower portion 65 of the stem is bent laterally of the major portion 66 of the stem for engaging beneath the boards that are commonly used in forming wood-type outdoor patios, porches and outdoor walkways. Thus, referring to FIG. 8, a pot is shown resting upon the boards 67 of a porch. Here, a retainer is shown as hooked over the upper end of the pot and extending through the gap between two adjacent boards of a porch or deck and with its lower laterally bent portion 65 either pre-bent or bent during installation underneath the adjacent board. In this instance, the retainer is shown as having a straight stem portion 66.

The bent holding member may be pre-formed and may be manipulated through the space between two adjacent boards and then turned sufficiently to contact the undersurface of the board upon which the pot is rested. Then the pot may be tipped slightly to insert its rim within the hook. Alternatively, and in some cases, the lower end portion of the stem would be bent in situ in order to first engage the hook at its upper end with the pot rim and then have its lower end portion bent sideways against the lower surface of the board.

When the retainer is applied, as shown in FIG. 4 or alternatively applied as shown in FIG. 8 upon a porch surface, the short leg of the hook may penetrate the filling of the pot. Thus, because the retainer is formed of a thin, metal wire, the contents of the pot are not disturbed by the retainer. Moreover, if the upper edge or rim of the pot is only partially fitted within the hook, ordinarily sufficient holding is provided by the hook to prevent tipping of the pot. Thus, there is an allowance for some inaccurate positioning of the retainer relative to the pot. Hence, the retainer may be used by unskilled persons and may be used carelessly without ordinarily affecting the operation of the retainer in normally holding the pot against tipping.

This invention may be further developed within the scope of the following claims. The foregoing description should be treated as a disclosure of a preferred, operative embodiment of this invention and not in a strictly limiting sense.

I claim:

1. A method for preventing tipping of a flower pot formed of an open top container having an approximately vertical wall formed with an upper edge portion and having a substantially closed bottom, joined to the wall, for resting the pot upon the ground in an area where the pot may be subjected to lateral forces which may tip the pot, comprising:
providing a retainer formed of a thin, stiff wire bent into the shape of a vertically elongated stem which is curved along its length and with an upper end of the stem bent into a downwardly opening, inverted U-shaped, hook portion having a short leg for extending downwardly adjacent the stem and being spaced apart from the stem for holding the container wall upper edge portion within the hook portion while the short leg may extend downwardly into the pot and into any potting material contained in the pot while the stem extends downwardly closely along the side of the pot for extending into the ground;
positioning the retainer along the side of a pot and pushing it downwardly adjacent the pot and into the ground;
engaging the hook portion over the upper edge portion of the pot while moving the stem downwardly closely adjacent to the outside surface of the pot wall while pushing the stem into the ground so that the lower part of the stem portion moves into the ground beneath the bottom of the pot and radially inwardly of the bottom of the pot.

2. A method as defined in claim 1, and said wire being formed of a relatively resilient metal material, and receiving and resiliently gripping the upper edge portion of the pot wall with the hook portion.

3. A method as defined in claim 1, and including providing a second retainer, similar in shape to said first mentioned retainer, and engaging the hook portion of the second retainer with the upper portion of the pot at a location spaced from the first mentioned retainer and into the ground beneath and radially inwardly of the bottom of the pot for temporarily holding the pot at spaced-apart locations in a fixed position upon the ground.

4. A method as defined in claim 1, and including arranging the stem in substantial contact with the pot at the junction of the side wall of the pot and the bottom of the pot while pushing the stem into the ground so that the stem moves endwise in a curved direction underneath the pot bottom for positioning a lower portion of the stem underneath the pot bottom.
